(19) United States
(12) Patent Application Publication
(10) Pub. No.: US 2017/0074589 A1
(43) Pub. Date: Mar. 16, 2017

(54) System and Method for Facilitating the Maintenance of an Industrial Furnace

(71) Applicant: Ipsen Inc., Cherry Valley, IL (US)

(72) Inventors: Geoffrey Somary, Arlington Heights, IL (US); Craig Moller, Roscoe, IL (US); Jim Grann, Rockton, IL (US); Aymeric Goldsteinas, Rockton, IL (US)

(21) Appl. No.: 15/259,617

(22) Filed: Sep. 8, 2016

Related U.S. Application Data
(60) Provisional application No. 62/217,230, filed on Sep. 11, 2015.

(51) Int. Cl. F27D 21/00; F27D 19/00; F27D 21/04; G05B 23/02

(52) U.S. Cl. CPC F27D 21/00; G05B 23/024; F27D 19/00; F27D 21/04; G05B 2219/24019; F27D 21/0021; F27D 2021/0057

(57) ABSTRACT

A system and method for facilitating the maintenance of an industrial heat treating furnace are disclosed.

### CROSS REFERENCE TO RELATED APPLICATIONS

This application claims the benefit of U.S. provisional patent application No. 62/217,230, filed Sep. 11, 2015, the entirety of which is incorporated herein by reference.

### FIELD OF THE INVENTION

The present invention relates generally to a system and method for facilitating the maintenance of an industrial heat treating furnace and more particularly, but not exclusively, to a system and method for automatically determining whether an industrial furnace requires or will require maintenance due to a failure condition in one or more furnace components.

### BACKGROUND OF THE INVENTION

In the world of heat treatment, furnaces must often withstand extreme conditions. However, for consistent, high-quality results, the furnace should be kept in excellent condition. While there are various ways to perform maintenance, there are still occasions where the furnace may break down, resulting in lost production and furnace downtime.

Accordingly, there is a need in the field for systems and methods that maintain industrial furnaces and both indicate when furnace maintenance is required and predict when furnace maintenance will be required to ensure continued operation of the furnace.

Vacuum and atmospheric furnaces are complex systems for heat treatment of various materials, such as, for example, metallic materials. During the heat treatment process, there are various important factors that determine the outcome. In a vacuum furnace, these factors include the pressure, temperature, and a defined atmosphere. Furnaces may also include controlled cooling processes or quenching processes. For these parameters to be precisely controllable, the relevant furnace components have to work accurately and without failure. The various systems of the vacuum furnace (e.g., heating, vacuum, pumping, and cooling systems), therefore, must be kept in good condition. Accordingly, the present invention provides systems and methods for maintaining the condition of a furnace and identifying or predicting failure conditions associated with the various systems and components of the furnace.

### SUMMARY OF THE INVENTION

Regarding the present system and methods of the invention broadly, the system includes a connected furnace that may communicate with a local terminal or dashboard that provides a display where a furnace user may monitor the health and status of the various furnace components. A benefit of the invention is that the local terminal may be placed at a monitored furnace and does not require a connection to the furnace's programmable logic controller (PLC) or proprietary control interface.

During operation, the local terminal may communicate with a remote server that may allow third parties, such as field service technicians, to also monitor the health and status of the various furnace components and check sensors at the furnace to: provide error detection, check or scan for current faults and errors, perform diagnostic service and repair, and provide preventative and proactive maintenance, as needed. The local terminal may also communicate with a remote server to allow certain third parties to monitor furnace performance and maintenance data for all furnaces that may be connected to the remote server of the system. Here and throughout the Specification and Claims the term “local terminal” means a computing device that is located on or adjacent to the furnace to which it is connected. Here and throughout the Specification and Claims the term “remote server” means a computing device connected to the internet or other network and which may be located in the same facility as a furnace to which it is connected or in a facility that is remote from the facility where the connected furnace is located. The remote server may be embodied as a physical server or it may be cloud based.

In one aspect, the invention includes a system for aiding in the maintenance of an industrial heat treating furnace. The system may include a plurality of sensors connected to a corresponding plurality of furnace components. Each of the sensors may be configured to sense a parameter associated with operation of one of the furnace components. The sensors may also be configured or programmed to generate a signal that may be representative of the sensed furnace parameter.

The system may include a computing system, processor, or a group of processors that may be connected to communicate with and receive the signals from the plurality of sensors. The computing system may be programmed to: (1) convert the signals from the sensors into a plurality of data elements; (2) select representative data elements from each of the plurality of data elements where the representative data elements may be indicative of the parameter sensed by one of the sensors; (3) analyze the representative data elements using a predictive processing methodology, to determine whether one or more of the furnace components requires maintenance or will require maintenance; and then (4) display information indicative of a status of one or more of the furnace components based on the analysis of the representative data elements.

The predictive processing methodologies of the invention may include one or more of a trend process, a rate of change process, and a predetermined value comparison process.

The trend process may include comparing the representative data elements over a period of time and determining whether the representative data elements define a trend that indicates a failure condition associated with one or more of the furnace components as compared to a reference trend. The rate of change process may include comparing the representative data elements over a period of time and determining whether a rate at which the representative data elements change in value indicates a failure condition associated with one or more of the furnace components as compared to a reference rate of change. The predetermined value comparison process may include comparing the representative data elements to one or more predetermined values indicative of a failure condition and determining whether the representative value indicates a failure condition associated with one or more of the furnace components as compared to the one or more predetermined values.

In another aspect, the invention includes a method for automatically determining whether (1) a component of a furnace requires maintenance because of a present failure condition; and/or (2) a component of the furnace will require maintenance because of an expected failure condition.

The method may include sensing parameters associated with operation of furnace components with a plurality of sensors connected to a corresponding plurality of furnace components. After sensing, the method may include generating signals that may be representative of the sensed parameters with the plurality of sensors. The method may further include receiving the signals from each sensor at a computer system. The computer system may be associated with the furnace and may be programmed to perform the following steps;
i. converting the signals from each sensor into a plurality of data elements;
ii. selecting representative data elements from each of the plurality of data elements, the representative data elements being indicative of a parameter associated with operation of one or more of the furnace components; and
iii. analyzing the representative data elements by a predictive maintenance process or routine selected from the group consisting of a trend process, a rate of change process, a predetermined value comparison process, and a combination thereof.

After processing and analysis, the method may include displaying information indicative of a status (e.g., a failure status or maintenance status) of one or more of the furnace components based on the analysis of the representative data elements.

Predictive maintenance, as provided by the systems and methods of the invention, is based on monitoring in-service equipment and determining when maintenance should be performed. The system and methods of the invention prevents equipment failures before they occur and may schedule maintenance, as needed.

The benefits of the present invention are numerous. The system may provide (1) a real time dashboard for monitoring furnace representative data; (2) an optional cloud based server for monitoring furnace representative data; (3) the ability to monitor a number of furnaces connected via local terminals to a single remote server; (4) the ability to operate the system through a local terminal independently should a connection to the remote server fail; and (5) the ability to monitor and maintain a connected furnace from a remote server automatically in order to maintain the longevity of the furnace for an end user.

### BRIEF DESCRIPTION OF THE DRAWINGS

The foregoing summary and the following detailed description of the exemplary embodiments of the present invention may be further understood when read in conjunction with the appended drawings, in which:

FIG. 1 schematically illustrates an exemplary furnace maintenance system 1 of the invention.

FIG. 2 schematically illustrates an additional exemplary furnace maintenance system 2 of the invention.

FIG. 3 schematically illustrates an exemplary furnace maintenance system 3 of the invention that demonstrates a deployment of various furnace sensors on a vacuum furnace.

FIG. 4 schematically illustrates an exemplary method 1000 of maintaining a furnace.

FIG. 5 schematically illustrates an exemplary trend process 1080 for analyzing data elements that are representative of a furnace parameter.

FIG. 6 schematically illustrates an exemplary rate of change process 1090 for analyzing data elements that are representative of a furnace parameter.

FIG. 7 schematically illustrates an exemplary comparison process 1100 for analyzing data elements that are representative of a furnace parameter.

### DETAILED DESCRIPTION OF THE INVENTION

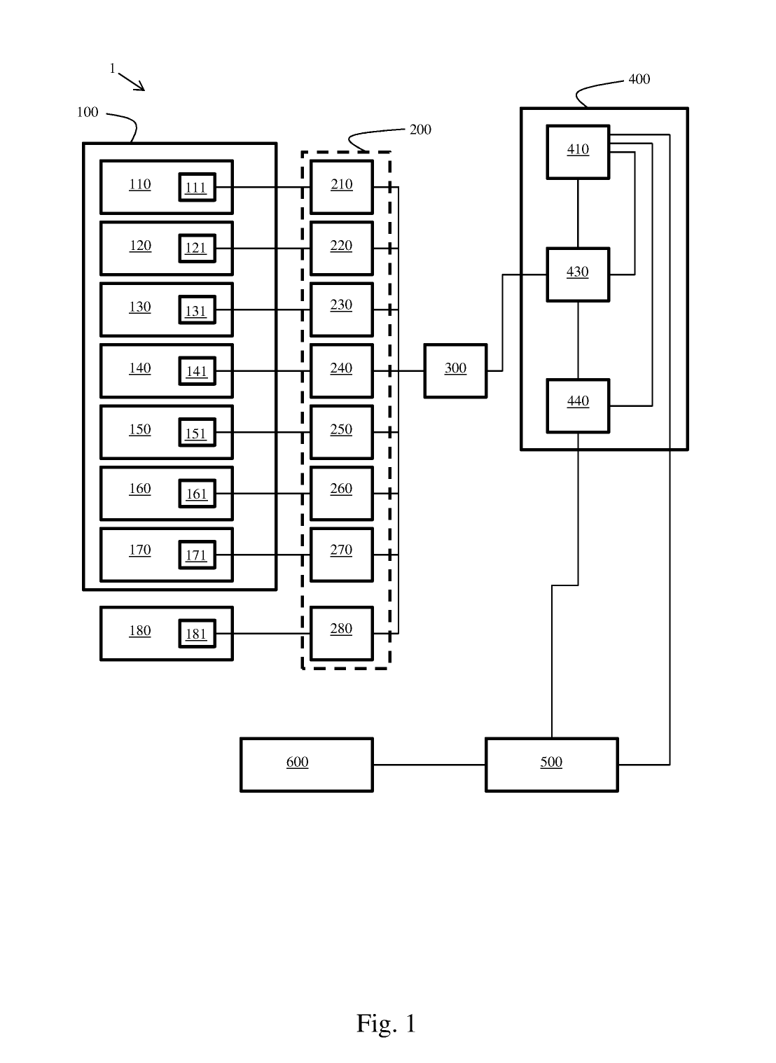

Referring now to the figures, wherein like elements are numbered alike throughout, FIG. 1 provides an exemplary system 1 for maintaining or otherwise aiding in the maintenance of an industrial heat treating furnace 100.

Industrial heat treating furnaces are generally defined as either (1) positive pressure or atmospheric furnaces which operate at about standard atmospheric pressure; or (2) vacuum furnaces, which heat a material under a vacuum. Certain heat treatment processes dictate the use of a vacuum during some period of a heating cycle. As used herein, “vacuum furnace” means a furnace that applies a vacuum in the furnace chamber during any portion of a heat treating cycle. For example, if a vacuum is used only to purge the furnace chamber prior to performing a heating and cooling heat treating process at positive pressure, the furnace is a vacuum furnace. In certain preferred aspects, the furnace 100 is a vacuum furnace.

Various exemplary furnaces are known in the art and include those furnaces and related components described in U.S. Pat. Nos. 8,747,731, 5,883,361, 5,930,285, 5,965,050, 8,313,586, 8,333,852, 8,662,888, 8,246,901, 8,465,603, 8,280,531, 8,175,744, 7,559,995, 6,794,618, 4,610,435, 4,251,809, 4,559,631, 4,368,037, 4,906,182, 4,560,348, 4,608,698, 4,612,651, 5,502,742, and 7,255,829; and U.S. Patent Application Publication Nos. 20150072297, 20140106287, 20120276494, 20120247627, 20130175741, 20130177860, 20140090754, and 20130175256. Vacuum furnaces, and components related to the operation of vacuum furnaces, are also known in the art as described in U.S. Pat. Nos. 4,212,633, 4,225,744, 4,227,032, 4,245,943, 4,246,434, 4,247,734, 5,059,757, 5,567,381, 5,709,544, 6,533,991, 6,749,800, 6,756,566, 6,903,306, 6,910,614, 7,105,126, 8,992,213, 8,694,167; and U.S. Patent Application Publication Nos. 20130175251, 20130175256, 20130209947, and 20150049781. Each U.S. patent and U.S. patent application Publication is incorporated by reference herein.

Furnace 100 may include a variety of furnace systems and components used to operate the furnace 100. Furnace 100 may include a gas system 110, a control system 120, a cooling system 130, a hot zone 140, a vacuum integrity system 150, a pumping system 160, a transport system 170, or a combination thereof. In addition, the system of the invention may include an atmospheric monitoring system 180 that may be encompassed within the furnace 100 or may be proximate to the furnace 100. For example, the atmospheric monitoring system 180 may be mounted directly to the furnace 100 or may be placed in the vicinity of the furnace 100 (e.g., the same room as the furnace) in order to monitor the atmospheric or ambient conditions surrounding the furnace 100.

Each of the foregoing systems of the furnace 100 may further include one or more corresponding system components (e.g., components 111, 121, 131, 141, 151, 161, 171, and 181).

Referring to exemplary components of the system 1, the furnace 100 may include a gas system 110. The gas system 110 may be provided at the furnace 100 to measure properties of gas remaining inside the furnace during operation. In addition, gas system 110 may include a system for depositing gas into a portion of the furnace, such as the hot zone 140. Indeed, the gas system 110 may include a mechanism for injecting an inert gas into the hot zone 140. The gas system 110 may include a gas system component 111, which may be a device for measuring a dew point in the gas of the furnace. Dew point is measured and monitored in vacuum furnaces, for instance, to prevent discoloration of a part during heat treatment.

The furnace 100 may include a control system 120 that is located at the furnace 100 and communicates with the various systems and components located at the vacuum furnace that may be electronically manipulated (e.g., modulated, activated, or deactivated). For instance, the control system 120 may include various components 121, such as circuitry that allows a user to initiate electrical activation of the furnace, temperature adjustment, and/or pump initiation. The control system 120 may also include a transceiver for receiving instructions from a transmitter and locally controlling components of the furnace 100 according to such instructions. In addition, the control system 120 may include circuitry to locally power down or deactivate the furnace 100.

In certain embodiments, the control system components 121 of the control system 120 may include a control processor, deactivation/activation circuitry, a cold cathode, and a controller thermometer, for example.

The terms “processor” and “microprocessor” as used herein are broad terms and, unless more specifically indicated, are to be given their ordinary and customary meaning to a person of ordinary skill in the art, and furthermore refer without limitation to a computer system, state machine, and the like that performs arithmetic and logic operations using logic circuitry that respond to and process the basic instructions that drive a computer. The system of the invention may also include data storage devices that include non-transitory media, such as floppy disks and diskettes, compact disk (CD)-ROMs (whether or not writeable), DVD digital disks, RAM and ROM memories, computer hard drives and back-up drives, external hard drives, “thumb” drives, and any other storage medium readable by a computer for the storage of electronic data, in any form, as described herein.

The furnace 100 may include a cooling system 130 that includes various components 131 for cooling portions of the furnace 100 before, during, and/or after a heat treatment cycle. For example, the cooling system 130 may be connected to and in fluid communication with the hot zone 140 and any exterior or interior surface of the hot zone 140. The cooling system 130 may include a cooling system component 131 such as a blower (e.g., a fan) and a heat exchanger. The blowers utilized in the furnaces of the invention may include a motor and one or more seals and bearings.

The furnace 100 may include a hot zone 140, which may be described as a compartment of the furnace 100 where the heating takes place and which may include various hot zone components 141 such as thermal insulation and a heating element.

The furnace 100 may include a vacuum integrity system 150, which may be described as a system employed by vacuum furnaces to maintain a vacuum created within the furnace 100 at a pressure vessel during heat treatment where the pressure vessel may contain the hot zone 140. Accordingly, the vacuum integrity system 150 may include vacuum integrity system components 151 such as a pressure vessel that may enclose the hot zone 140 during heat treatment and one or more seals (e.g., O-ring seals) employed at a door of the furnace 100 or pressure vessel to prevent fluid (e.g., gas) from entering or escaping the pressure vessel and/or the hot zone 140.

The furnace 100 may include a pumping system 160 connected to and in fluid communication with a pressure vessel and the hot zone 140 and may include a pumping system component 161 such as one or more pumps for evacuating gas from the pressure vessel and/or the hot zone 140 when operating a vacuum furnace. The pumping system component 161 may include a roughing pump, a booster pump, a holding pump, and/or a diffusion pump.

Furnace 100 may be a continuous furnace or a batch furnace. The furnace 100 may be a continuous furnace that includes a transport system 170 that may be used to transfer materials or batches of materials to be heat treated between different treatment zones or treatment chambers of the furnace 100. For example, the furnace 100 may be a furnace having more than one hot zone 140 and the transport system 170 can encompass a collection of components that allow for the movement of a material to be treated from one hot zone to another. In another embodiment the furnace 100 may be a furnace having a hot zone and a cooling zone or a quenching chamber. In such case the transport system 170 can encompass a collection of components that allow movement of the material to be treated from the hot zone to the cooling zone or to the quenching chamber. For example, the transport system 170 may include a pusher, a belt, a roller, a moving hearth, a walking beam, or a combination thereof. Accordingly, the transport system 170 may include components 171, which may include a system for transporting a material or batches of materials from one hot zone to another or to a quenching chamber after heat treatment in the hot zone.

The system may include an atmospheric monitoring system 180 that may be encompassed within the furnace 100 or may be placed proximate to the furnace 100. Specifically, the atmospheric monitoring system 180 may include components 181, which may include an air conditioning unit, a thermometer, a barometer, and a hygrometer, for example. The atmospheric monitoring system 180 may both monitor the atmospheric conditions surrounding the furnace 100 and modify those conditions by employing one or more of the atmospheric monitoring system components 181 within the system 180. The atmospheric monitoring system 180 may also include a weather station.

The system 1 may also include a number of sensors 200 that may be in communication with or otherwise connected to one or more furnace components. The sensors 200 may sense a parameter that is associated with the operation of a corresponding furnace component. Sensing parameters that are associated with the operation of a furnace component include both receiving data generated by the furnace components and monitoring the activity or function of the furnace components. The sensors 200 may generate sensor data or sensor signals that are representative of a parameter that is associated with the operation of one or more furnace components. The generated sensor signals or sensor data may include analog or digital signals that are representative of a measured parameter from one of the sensors 200. The data signals can contain raw data, but may also contain calibrated and/or filtered data.

The sensors 200 of the invention may be communicatively coupled to one or more of the furnace components. The terms “communication” and “communicatively coupled” are defined herein, unless more specifically indicated (e.g, electrical communication, chemical communication, electrochemical communication), as a general state in which two or more components of the system 1 (e.g., one of the sensors 200 and a furnace component) are connected such that communication signals are able to be exchanged (directly or indirectly) between the components on a unidirectional or bidirectional (or multi-directional) manner, either wirelessly, through a wired connection, or a combination of both as would be understood by a person having ordinary skill in the art.

The system 1 may include a variety of sensors 200 that are communicatively coupled to a furnace component including, for example, a door wall temperature sensor, a roughing pump oil temperature sensor, a holding pump oil temperature sensor, a blower vibration sensor, a blower amperage sensor, a dew point measurement sensor, a power feed through water temperature sensor (i.e., a temperature sensor, such as a thermocouple, positioned in a water stream exiting a power terminal of the furnace), a diffusion pump water temperature sensor, a differential pressure roughing pump sensor, a diffusion pump oil temperature sensor, a diffusion pump power meter sensor, a furnace ohm meter sensor, an arc detection sensor, a furnace voltage sensor, a pumping time to cross over sensor (i.e., a sensor, which includes a timer, that measures the time from the initiation of a pumping cycle to the time when pressure within the furnace crosses over a threshold pressure or level required to heat a part within the furnace), a furnace amperage sensor, a heating element resistance sensor, a heating power current sensor, a heating power voltage sensor, a vessel water temperature sensor, a front head water temperature sensor, a heat loss sensor, a pumping down time sensor, a leak-up rate sensor, a valve integrity sensor, a pump vibration sensor, a pressure drop heat exchanger sensor, a pump amperage sensor, a cooling water circuit outlet temperature sensor, an incoming water temperature sensor, a mechanical pump oil temperature sensor, a diffusion pump heating power sensor, a mechanical pump exhaust back pressure sensor, an ambient temperature sensor, an ambient humidity sensor, an ambient barometric pressure sensor, an inert gas supply dew point sensor, a furnace temperature sensor, a furnace pressure sensor, a vacuum level sensor, a heating element voltage sensor, a heating element amperage sensor, a furnace run status sensor (e.g., in cycle status, cycle hold status, out of cycle status), a mechanical pump run contactor sensor, a furnace heat enable contactor sensor, a resistance to ground sensor, an O-ring seal sensor, and/or an open-circuit detector sensor.

In certain embodiments, the system 1 may include a gas system component sensor 210, a control system component sensor 220, a cooling system component sensor 230, a hot zone sensor 240, a vacuum integrity system sensor 250, a pumping system component sensor 260, a transport system component sensor 270, and/or an atmospheric monitoring system component sensor 280.

The gas system sensor 210 may include, for example, a dew point sensor.

The control system sensor 220 may include, for example, a cold cathode sensor, a furnace active/inactive sensor (e.g., an on/off sensor), and/or a controller temperature sensor.

The cooling system sensor 230 may include, for example, a vibration sensor (e.g., a blower vibration sensor) and a blower amperage sensor. The vibration sensor may be used to avoid a major breakdown of the cooling system components because the magnitude and/or frequency of vibration present in the system indicates the severity of the problem causing the vibration

The hot zone sensor 240 may include, for example, a resistance to ground sensor, an arc detection sensor, a heating element resistance sensor, a heating power current sensor, a heating power voltage sensor, a vessel water temperature sensor, a front head water temperature sensor, a furnace temperature sensor, an open circuit sensor, and/or a power feed through water temperature sensor. Resistance to ground sensors indicate hot zone cleanliness, which can be used to prevent arcing at the heating element that could result in heating element damage. Open circuit sensors may be used to indicate uniformity of heating and provide an indication that the heating elements are connected. The power feed through water temperature sensors provide temperature data that may be utilized to avoid seal damage.

The vacuum integrity sensor 250 may include a pressure sensor and/or a leak sensor. More specifically, the vacuum integrity sensor 250 may include a pumping time to crossover sensor and/or a leak up rate sensor. The pumping time to cross over sensor and leak up rate sensor may be used to detect a leak in a pressure vessel at the vacuum integrity system 150 of furnace 100 and may also be used to monitor pumping performance. Additionally, the pumping time to cross over sensor and leak up rate sensor may be monitored during a treatment to prevent discoloration in a part subjected to heat treatment.

The pumping system sensor 260 may include, for example, an oil temperature sensor, a power sensor, a pressure sensor, and/or a water temperature sensor. More specifically, the pumping system sensor 260 may include a roughing pump sensor, vacuum booster sensor, diffusion pump sensor, and/or a holding pump sensor. The vacuum booster sensors may be selected from the group consisting of a run time sensor, a temperature sensor, a pressure sensor, and a combination thereof. The roughing pump sensors may be selected from the group consisting of a run time sensor, a temperature sensor (e.g, an oil temperature sensor), a pressure sensor (e.g., an exhaust pressure sensor), and a combination thereof. The diffusion pump sensors may be selected from the group consisting of a run time sensor, a temperature sensor (e.g., an oil temperature sensor, a water in temperature sensor, and a water out temperature sensor), a heating power usage temperature sensor, and a combination thereof. The holding pump sensors may be selected from the group consisting of a run time sensor, a temperature sensor (e.g., oil temperature sensor), a pressure sensor, and a combination thereof.

The transport system sensor 270 may include, for example a material location sensor and/or a status sensor. The material location sensor may be used to detect the presence of a batch of material in the furnace 100 where the material may be moved from one portion (e.g., hot zone) of the furnace to another with a pusher mechanism, a belt mechanism, a roller mechanism, a moving hearth mechanism, a walking beam mechanism, or a combination thereof. The status sensor may be used to indicate a status of the transport system and, more specifically, an operation status (e.g., a status indicating that a mechanism of system 170 is operating normally or has a fault) of the components being used to transport a material to be subjected to heat treatment from one portion of the furnace 100 to another.

The atmospheric system sensor 280 may include, for example, an ambient temperature sensor, an ambient pressure sensor, and/or an ambient humidity sensor.

In certain preferred embodiments of the invention, the furnace 100 is a vacuum furnace and the system 100 includes one or more of a pump sensor, a hot zone sensor, a vacuum sensor, a cooling system sensor, and an atmosphere sensor.

The sensors 200 may be communicatively coupled to a sensor data receiver 300. The sensor data receiver can be a data logger. As used herein, the term “data logger” may refer to either a separate data-logging device (e.g., a digital data recorder) or a data logging function performed by one or more hardware or software components of a local terminal 400 or remote server 500. The sensor data receiver 300 may be a hardware system that sensors 200 are connected to and may aggregate sensor data received from said sensors. In one embodiment the sensor data receiver 300 may store the data on a non-transitory storage medium as described herein and/or known by persons skilled in the art. Where any one of the sensors 200 provides data in an analog signal format (e.g., voltage, amperage), the sensor data receiver 300 may convert such analog data to a digital signal format with one or more A/D converters.

The sensor data receiver 300 may be communicatively coupled to an on-site computer system such as local terminal 400. In certain alternative embodiments, the sensor data receiver 300 may be omitted and the sensors 200 may be connected directly to the local terminal 400 where an input/output component of the local terminal 400 is programmed to function as the sensor data receiver 300.

The local terminal 400 may be placed proximate to the furnace 100. For example, the local terminal 400 may be physically mounted on the furnace 100. Alternatively, the local terminal 400 may be provided in a separate housing that is in the vicinity of the furnace 100 (e.g., within the same room as furnace 100).

The local terminal 400 may include, for example, a user interface 410, data reader 430, and/or a data transmitter 440. In alternative embodiments, the local terminal 400 may also include a furnace controller 420.

The data reader 430 may be a processor having one or more ports that allow for the reception of sensor data from the sensor data receiver 300. Alternatively, the data reader 430 may have circuitry and one or more ports that allow for the reception of sensor data directly or indirectly from one or more of the sensors 200. In certain aspects, the data reader 430 may be a software component of the local terminal 400 that may collect and aggregate data received from sensor data receiver 300. The data reader 430 may also include an embedded event processing (EP) system. As used herein, the term “event processing system” refers to a computerized system that is configured to: track and analyze data from one or more of sensors 200 and derive a conclusion based on such analyzed data. The embedded EP system may be a complex event processing (CEP) system. In preferred embodiments, the embedded EP system is a small footprint complex event processor that runs certain business rules or maintenance routines based on component maintenance conditions, as described herein, to process sensor data and provide information (i.e., data reader output) that is indicative of a status of one or more of the furnace systems and components.

The data reader 430 may be connected and communicatively coupled to the user interface 410, and the data transmitter 440. Specifically, the data reader 430 may process the sensor data received from the sensor data receiver 300 and may then display raw data and/or processed data from the sensors at the user interface 410. The data reader 430 may also transmit raw sensor data or processed sensor data through the data transmitter 440 to a remote server 500. The data reader 430 may operate in conjunction with the data transmitter 440 to be responsive to a furnace failure event-driven request, the request being generated either automatically or due to a user command, to transmit raw or processed sensor data to the remote server 500. For example, the furnace failure event may require a powering down of a heating element due to arcing. The information regarding furnace failure event (i.e., arcing) could be sent to a remote server 500 and a failure event-driven request could be provided automatically by the remote server 500, instructing a user to power down the heating element of the subject furnace. In alternative embodiments where the local terminal 400 includes a furnace controller 420, the data reader 430 may be connected and communicatively coupled to the furnace controller 420. For example, the data reader 430 may process the sensor data and vary or modify a parameter of the furnace 100 through the furnace controller 420 either automatically or in response to a user input at the user interface 410.

The user interface 410 may be a graphical user interface that allows a user to (1) view raw sensor data or processed sensor data from the data reader 430 (2) submit instructions to the furnace regarding the operation of the furnace or, more specifically, the operation of one or more furnace components; (3) visualize information, instructions, and/or software received at the local terminal 400 from the remote server 500; (4) provide instructions to the data reader 430 regarding business rules to be used for the evaluation of sensor data; and (5) communicate with a third party technician regarding the status or maintenance of the furnace 100. Preferably, the user interface 410 includes a real time dashboard that allows a user to interact with the system of the invention and view and interpret sensor data in real time.

More broadly, the user interface 410 may include at least one of textual, graphical, audio, video, animation, and/or haptic elements. A textual element may be provided, for example, by a printer, monitor, display, projector, etc. A graphical element may be provided, for example, through a monitor, display, projector, and/or visual indication device, such as a light, flag, beacon, etc. An audio element may be provided, for example, through a speaker, microphone, and/or other sound generating and/or receiving device. A video element or animation element may be provided, for example, through a monitor, display, projector, and/or other visual device. A haptic element may be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc.

In preferred aspects, e local terminal 400 includes a real-time dashboard at the user interface 410.

The system 1 may include a remote server 500 that is communicatively coupled to the local terminal 400. In certain embodiments, the remote server 500 may be connected to the data transmitter 440 and the user interface 410. The remote server 500 may include one or more processors and non-transitory storage media. The remote server 500 may include one or more transceivers having circuitry configured to receive raw or processed sensor data from the data transmitter 440. In addition, the one or more transceivers of the remote server 500 may have circuitry configured to transmit remote data to the user interface 410, which may be processed by the data reader 430. For example, the remote server 500 may store historical sensor data and transmit such historical sensor data to the local terminal 400 for processing by the data reader 430.

The remote server 500 may also be communicatively coupled to the local terminal 400 through the internet as would be understood by a person having ordinary skill in the art. For instance, the transceivers of the remote server 500 may include one or more network adapters configured to transmit and receive data via the internet. The remote server 500 may also be a cloud computing system. As used herein, the term “cloud computing system” may refer to a computing platform or system where a user may have access to applications or stored data or other computing resources necessary to the system 1 over a network.

In certain aspects, at least one of the local terminal 400 and remote server 500 may be programmed to perform a predictive maintenance routine or predictive processing methodology, as described herein, through the data reader 430 upon receipt of sensor data from the various component sensors 200.

The system 1 may also include a remote user interface 600 that may be accessible through the internet and which is communicatively coupled to the remote server 500. The remote user interface 600 may include a real time dashboard that allows a remote user to access raw or processed sensor data from the furnace 100 and to communicate with the local terminal 400.

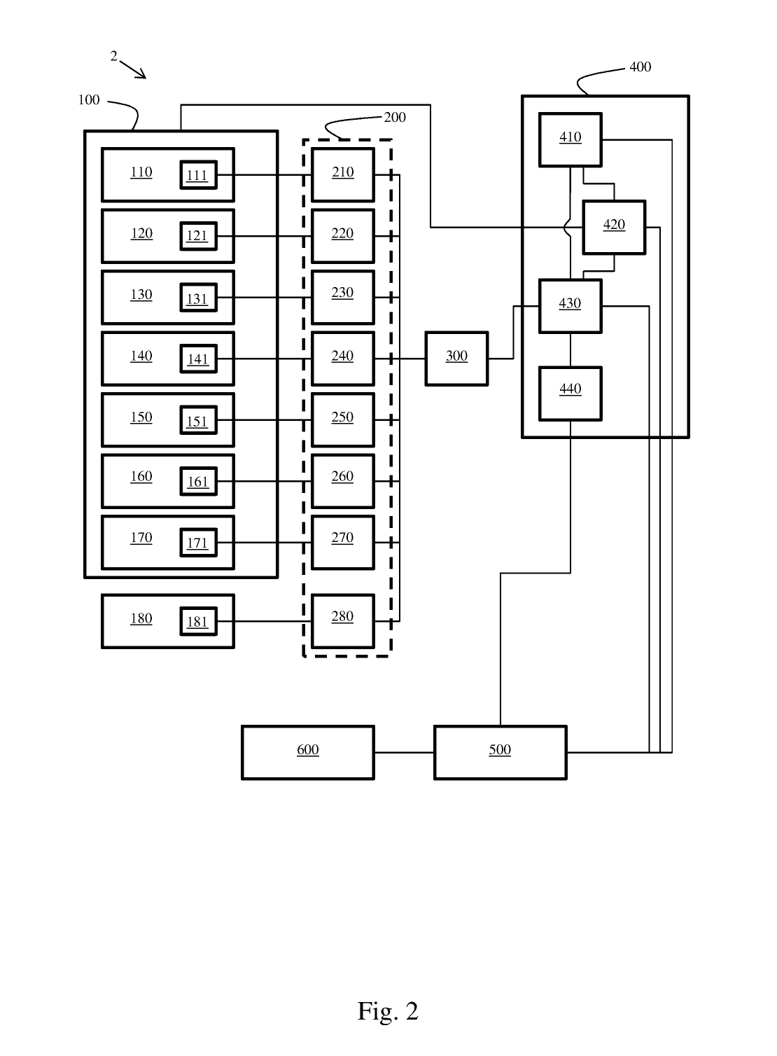

In an alternative embodiment of the invention described in FIG. 2, system 2 provides for the remote server 500 to be communicatively coupled directly to the user interface 410, the furnace controller 420, the data reader 430, and the data transmitter 440. In this embodiment, the remoter server 500 may transmit data to the user interface 410 and the data reader 430. In contrast to system 1, system 2 may include a remoter server 500 that may transmit instructions to a furnace controller 420 to directly control an operation of the furnace 100. For example, the remote server 500 may be configured to receive processed sensor data from the data reader 430 through the data transmitter 440 that indicates a present failure condition in the furnace 100. Upon receipt of such transmission, either a user at the remote interface 600 or the remote server 500 may transmit instructions to the furnace controller 420 to deactivate or “turn off” the furnace 100, or a component therein, through the control system 120 to prevent damage to the furnace 100.

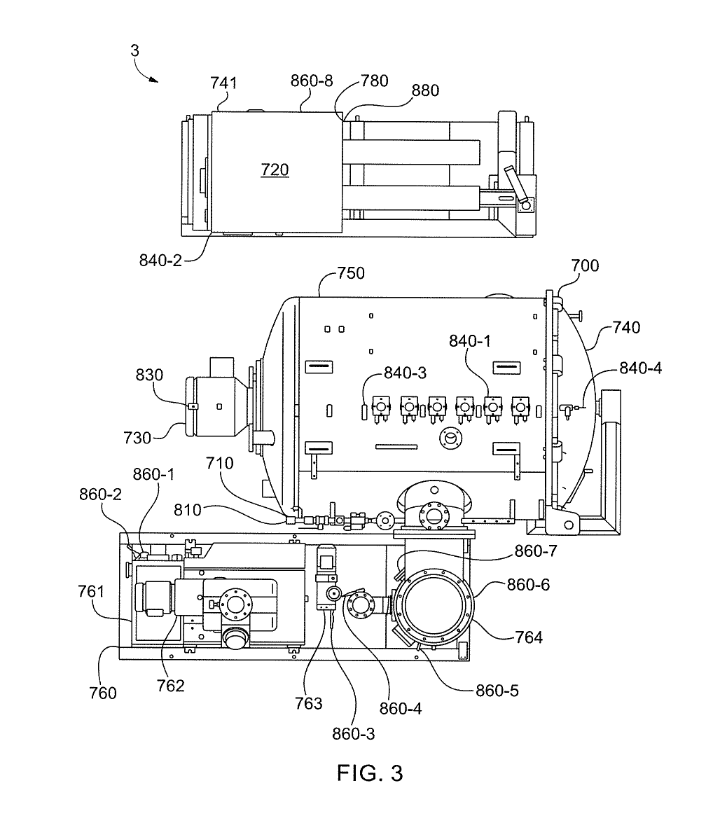

FIG. 3 discloses an exemplary furnace maintenance system 3 that describes a layout of sensors on a vacuum furnace 700. The system 3 includes a gas system 710, a control system 720, a cooling system 730, a hot zone 740, a pressure vessel 750 (i.e., the vacuum integrity system), a pumping system 760, and an atmospheric monitoring system 780. The hot zone 740 includes a set of heating element resistance instruments 741. The pumping system 760 includes a roughing pump 761, a booster pump 762, a holding pump 763, and a diffusion pump 764.

Various sensors are provided in system 3, which are placed at selected furnace components. For example, the gas system 710 includes a backfill gas dew point sensor 810. The cooling system 730 includes a gas blower motor vibration sensor 830. The hot zone 740 includes six power feed water temperature sensors 840-1, heating power current and voltage sensors 840-2, a vessel water temperature sensor 840-3, and a front head water temperature sensor 840-4. The pumping system 760 includes a roughing pump exhaust pressure sensor 860-1, a roughing pump oil temperature sensor 860-2, a holding pump oil temperature sensor 860-3, a diffusion pump water outlet temperature sensor 860-4, a diffusion pump water inlet temperature sensor 860-5, a diffusion pump power monitor 860-6, a diffusion pump oil temperature sensor 860-7, and pump hour meters 860-8. The atmospheric monitoring system 780 includes temperature and humidity sensors 880.

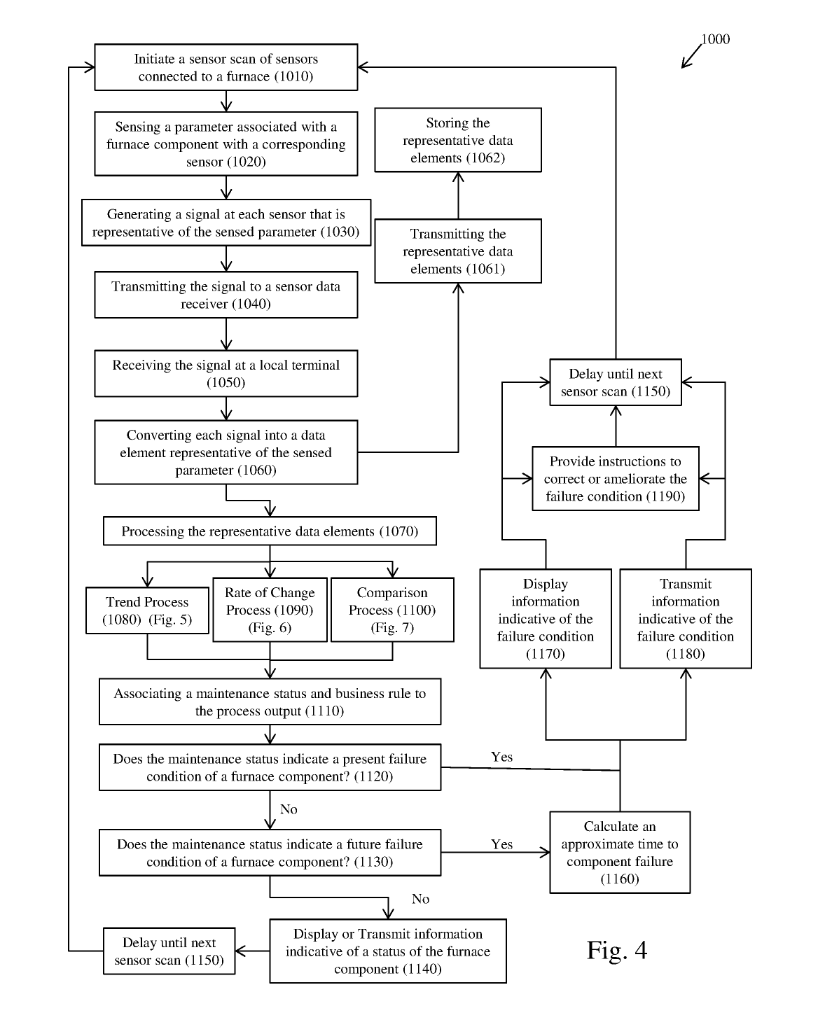

FIGS. 4 to 7 illustrate methods of maintaining furnace 100 using a furnace maintenance system according to the present invention, such as exemplary systems 1 and 2.

For example, the present invention includes method 1000 for (1) automatically determining whether a furnace component requires maintenance because of a present failure condition; and/or (2) automatically determining whether a furnace component will require maintenance because of an expected failure condition.

An exemplary method of the invention 1000 is set forth in FIG. 4 and begins at step 1010 with an initiation of a scan of sensors (i.e., sensors 200) that are connected to the furnace 100 or, more particularly, the various components of the furnace. The scan may be initiated at local terminal 400 or may be initiated by remote server 500. Alternatively, the sensor scan (step 1010) may be initiated at sensor data receiver 300, which may then proceed to monitor or otherwise read the sensor values for component sensors 200 at a scan interval, as described herein.

A preliminary step of the methods of the invention may be the placement of a plurality of sensors 200 at the furnace 100.

Moreover, the sensor scan (step 1010) may be initiated automatically as a programmed and scheduled scan. For example, the scan may occur on the order of seconds, minutes, or hours. Indeed, the initiation of a scan of the sensors 200 may occur on a scan interval which may vary from about 1 to 59 seconds, 1 to 59 minutes, or 1 to 24 hours. In certain preferred aspects of the invention, a scan may occur more frequently for critical components as compared to non-critical components. For example, critical component sensors may be scanned at 1 second intervals while non-critical component sensors may be scanned at 30 minute intervals.

Critical component sensors may be selected from the group consisting of hot zone component sensors, vacuum integrity component sensors, pumping system component sensors, cooling system component sensors, and a combination thereof. Non-Critical component sensors may be selected from the group consisting of gas system component sensors, transport system component sensors, atmospheric system component sensors, control system component sensors, and a combination thereof.

After the initiation of the sensor scan (step 1010), the sensors may sense a parameter associated with a furnace component (step 1020) and proceed to generate a signal that is representative of the sensed parameter (step 1030). The signal generated by each respective sensor may be an analog signal or a digital signal. The signal, which is representative of the sensed furnace parameter, may then be transmitted to a sensor data receiver 300 either automatically, upon a user request, or at a scan interval, as described herein (step 1040).

After receiving the signal at the sensor data receiver (step 1040), the sensor data receiver may process the signal by, for example, converting the signal to a digital signal where the signal from the sensor is an analog signal. Additionally, the sensor data receiver may store the signal data on a non-transitory storage medium. The sensor data receiver 300 may further transmit the signal from the component sensors (either in its raw or processed form) for receipt by a local terminal (step 1050). Indeed, the signal, which is representative of a sensed furnace parameter, may then be transmitted to the local terminal either automatically, upon a user request, or at a scan interval, as described herein. In certain preferred aspects of the invention, the signal data from the sensor data receiver 300 is received by a data reader 430 of the local terminal 400 for further processing and analysis.

Upon reception at the local terminal 400, the signal data from each component sensor (either in its raw or processed form) may then be converted at the local terminal into a data element representative of the sensed furnace parameter (step 1060). Converting the signal data to representative data elements may include, for example, (1) associating the identity of the sensed furnace component with the signal data; (2) translating the signal data into a selected unit of measurement that may be selected from the group consisting of degrees Fahrenheit, degrees Celsius, Kelvin, amperes, volts, ohms, watts, bar, pascal, torr, mmHg, and atmospheres; and/or (3) converting the signal data to what may amount to an “on/off” parameter or a “connected/disconnected” parameter (e.g., the signal data indicates an open circuit, an arcing heating element, etc.). In certain aspects, method step 1060 may be performed at a data reader 430, however, in alternative embodiments, method step 1060 may be performed remotely at a remote server 500.

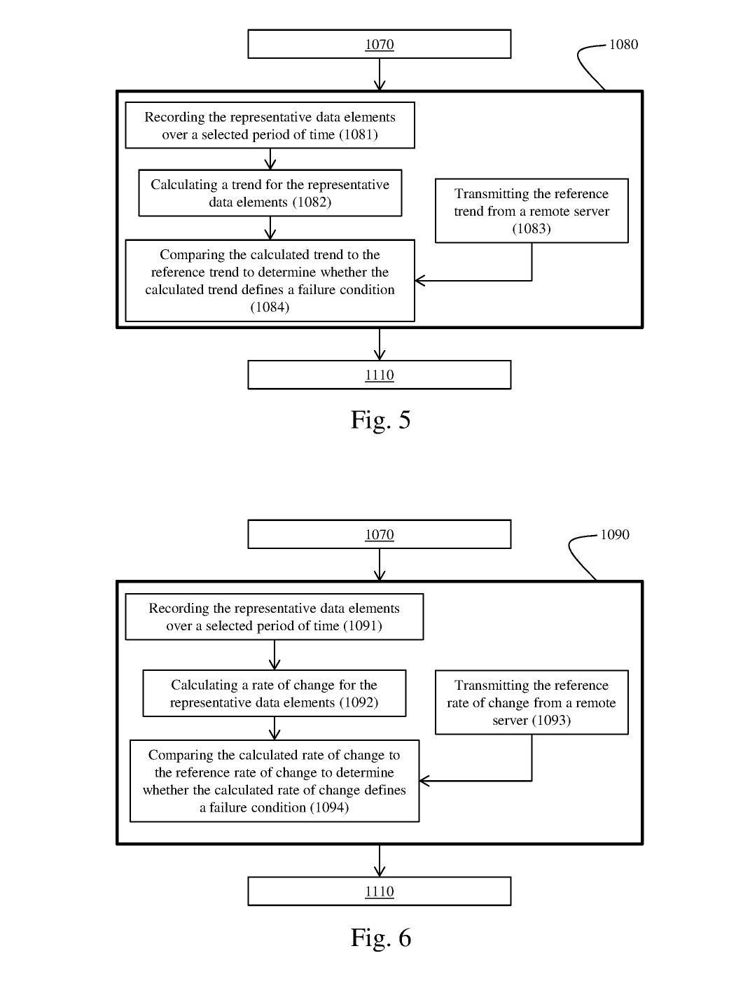

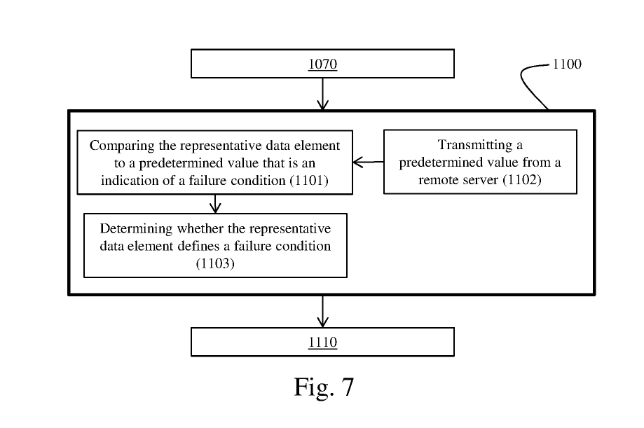

The resulting representative data elements may then be processed (step 1070) according to a predictive processing methodology that can indicate (1) the existence of a present failure condition in a furnace component; and/or (2) that a furnace component is expected to fail. The predictive processing methodologies of the invention utilize historical data that is indicative of a present failure condition or an expected failure condition for a furnace component such that when a representative data element substantially matches or otherwise corresponds to the historical data, a user may expect the present failure condition to exist or the expected failure condition to occur with a reasonable degree of certainty. As used herein, the term “substantially match” may refer to a comparison of two or more data elements (e.g., values, trends, slopes, functions, rates, and the like) where the two or more data elements are within an acceptable range. In certain embodiments, two or more data elements may be substantially matched when they are within 30% of each other. More preferably, two or more data elements may be substantially matched when they are within 20% of each other. Most preferably, two or more data elements may be substantially matched when they are within 10% of each other. The predictive processing methodologies of the invention may include a trend process (step 1080) (FIG. 5), a rate of change process (step 1090) (FIG. 6), and a predetermined value comparison process (step 1100) (FIG. 7).

As shown in FIG. 5, the trend process (step 1080) may include the steps of recording or storing the representative data elements at the local terminal 400 or the remote server 500 for a selected or predetermined period of time (step 1081). The selected period of time may be an interval of about 1 to 59 seconds, 1 to 59 minutes, 1 to 23 hours, 1 to 6 days, or 1 to 4 weeks. Based on the selected period and the recorded representative data elements, the method may include calculating a trend for the representative data elements, which may be plotted graphically (step 1082). A reference trend, based on the historical data, may be transmitted from a remote server 500 to the local terminal 400, wherein the reference trend is indicative of a present or future failure condition for a furnace component (step 1083). Alternatively, the calculated trend data may be transmitted to the remote server 500 for processing. The calculated trend may then be compared to the reference trend to determine whether the calculated trend substantially matches the reference trend such that a user may expect the present failure condition to exist or the expected failure condition to occur with a reasonable degree of certainty (step 1084).

As shown in FIG. 6, the rate of change process (step 1090) may include the steps of recording or storing the representative data elements at the local terminal 400 or remote server 500 for a selected or predetermined period of time (step 1091). The selected period of time may be an interval of about 1 to 59 seconds, 1 to 59 minutes, 1 to 23 hours, 1 to 6 days, or 1 to 4 weeks. Based on the selected period and the recorded representative data elements, the method may include calculating a rate at which the representative data elements change, which may be plotted graphically (step 1092). A reference rate of change, based on historical data, may be transmitted from a remote server 500 to the local terminal 400, wherein the reference rate of change is indicative of a present or future failure condition for a furnace component (step 1093). Alternatively, the calculated rate of change data may be transmitted to the remote server 500 for processing. The calculated rate of change may then be compared to the reference rate of change to determine whether the calculated rate of change substantially matches the reference rate of change such that a user may expect the present failure condition to exist or the expected failure condition to occur with a reasonable degree of certainty (step 1094).

As shown in FIG. 7, the predetermined value comparison process (step 1100) may include the steps of comparing at the local terminal 400 the representative data element to a predetermined value that is indicative of a present or future failure condition (step 1101), where the predetermined value is transmitted from the remote server (step 1102). Alternatively, the representative data element may be transmitted to the remote server 500 for processing and comparison to a predetermined value.

Based on the comparison between the representative data element and the predetermined value, a determination may be made as to whether the representative data element substantially matches the predetermined value such that a user may expect the present failure condition to exist or the expected failure condition to occur with a reasonable degree of certainty (step 1103).

Data from certain sensors 200 may be preferably processed by specific predictive processing methodologies. Representative data elements preferentially processed according to trend processes include, for example, pumping time to crossover data, leak up rate data, blower vibration data, resistance to ground data, power feed through water temperature data, pump oil temperature data, and heating power usage data. Representative data elements preferentially processed according to rate of change processes include, for example, arc detection data. Additionally, open circuit data is preferentially processed via a predetermined value comparison process.

After processing the representative data elements by one or more of the predictive processing methodologies (steps 1080, 1090, and 1100), the resulting process output may be assigned a maintenance status (step 1110). As used herein, the term “maintenance status” refers to a status of the furnace component based on a representative data element that indicates whether the operability of the furnace component is satisfactory (i.e., no present or future failure condition detected), under caution (i.e., there is a risk that a present failure condition may exist or that a future failure condition may occur), and in danger (i.e., within a reasonable degree of certainty, a present failure condition exists or a future failure condition will occur). These maintenance statuses may also be assigned by applying a predetermined business rule, which may include a process for determining the maintenance status associated with a furnace component.

As used herein, the term “business rule” refers to an analytical guide that may be used to determine whether a certain maintenance status exists for a furnace or a furnace component. For example, a business rule for a certain sensor may encompass comparing sensor data from a furnace component sensor to a value (e.g., a reference value from historical data) where: (1) if the sensor data exceeds the value, the operability of the furnace component is satisfactory; (2) if the sensor data substantially matches the value, the operability of the furnace component is under caution; and (3) if the sensor data is less than the value, the operability of the furnace component is in danger. Persons having ordinary skill in the art may recognize, based on the present application, that a variety of business rules may be developed for different sensors and may include ranges, threshold values, maximum values, and/or minimum values.

The methods of the invention may also include providing a tag or indicator associated with each maintenance status through an associated user interface to a user, which allows the user to readily understand that a furnace component has a satisfactory maintenance status, an under caution maintenance status, or an in danger maintenance status. For the purposes of this invention, the satisfactory maintenance status has a “green” indicator, the under caution maintenance status has a “yellow” indicator, and the in danger maintenance status has a “red” indicator.

After preparing a maintenance status for each scanned furnace component, the method includes a determination of whether the maintenance status indicates a present failure condition and is either under caution (yellow) or in danger (red) (step 1120). If the component is under caution or in danger, the systems of the invention may display such maintenance status information that is indicative of the failure condition at the user interface 410 of the local terminal (step 1170). Alternatively, such maintenance status information may also be sent to a remote server 500 and may be accessible via a remote user interface (step 1180).

If the maintenance status does not indicate a present failure condition, then the method may include a determination of whether the maintenance status indicates a future failure condition of a furnace component and is either under caution (yellow) or in danger (red) (step 1130). The method may also include a calculation of an approximate time to component failure as compared to the historical data (step 1160). Indeed, if there is future failure condition present, then the method may compare a representative data element related to the failing component to historical data that defines an approximate time to failure for similarly situated components.

If the component is under caution or in danger, then the systems of the invention may display such maintenance status information that is indicative of the failure condition, including the approximate time to failure, at the user interface 410 of the local terminal (step 1170). Alternatively, such maintenance status information may also be sent to a remote server 500 and may be accessible via a remote user interface (step 1180).

After displaying information indicative of a failure condition (step 1170) and/or transmitting information indicative of a failure condition (1180), the method may also include providing instructions to correct or ameliorate the present or future failure condition (step 1190). Step 1190 may include (1) displaying corrective instructions at the user interface 410 of the local terminal 400, which may, for example, be instructions stored at the local terminal 400 or transmitted to the local terminal 400 from a remote server 500; and/or (2) providing commands to automatically correct or ameliorate the present or future failure condition, where local terminal 400 includes a furnace controller 420. For example, upon detecting a failure condition, the local terminal 400 may automatically provide commands that direct the furnace 100 through a furnace controller 420 to take certain actions or perform a specific protocol (e.g., deactivate a component of the furnace 100). Alternatively, upon detecting a failure condition, commands or instructions may be provided from a remote server 500 that direct the furnace 100 through a furnace controller 420 to take certain actions or perform a certain protocol (e.g., deactivate a component of the furnace 100).

After one or more of displaying information (step 1170), transmitting information (step 1180), and providing instructions (step 1190), the method may include a delay period before returning to step 1010 and initiating another sensor scan. The delay period may include a delay interval of about 1 to 59 seconds, a 1 to 59 minutes, or 1 to 24 hours.

If the maintenance status indicates that a furnace component is operating satisfactorily (green), the method may include displaying such information indicative of the maintenance status at the user interface 410 of the local terminal 400 and/or transmitting the maintenance status information to a remote server (step 1140). The method may also include a delay period before returning to step 1010 and initiating another sensor scan. The delay period may include a delay interval of about 1 to 59 seconds, 1 to 59 minutes, or 1 to 24 hours.

An exemplary table describing certain component sensors 200 and their associated maintenance statuses, business rules, and resulting instructions based upon such maintenances status are provided in Table 1.

TABLE 1
Exemplary sensors with their associated maintenance statuses and
instructions.

| | | | Instruction issued to |
|---|---|---|---|
| | | | Local Terminal based |
| | | | on a Maintenance |
| Furnace System | Component Sensor | Maintenance Status | Status |
| Vacuum Integrity | Pumping time to | Green (Satisfactory) | No Action |
| System | crossover sensor | | |
| | | Yellow (Caution) | Backfill furnace to |
| | | | atmospheric pressure |
| | | | and restart treatment |
| | | | cycle |
| | | Red (Danger) | Backfill furnace to |
| | | | atmospheric pressure |
| | | | and restart treatment |
| | | | cycle. If the sensor |
| | | | value is greater than |
| | | | 40, check for leaks |
| | Leak up rate sensor | Green (Satisfactory) | No action |
| | | Yellow (Caution) | Perform burnout cycle |
| | | | and re-check leak up |
| | | | rate and valve |
| | | | sequence |
| | | Red (Danger) | Check for internal and |
| | | | external leaks. |
| Cooling System | Blower vibration | Green (Satisfactory) | No action |
| | sensor | | |
| | | Yellow (Caution) | Check vibration level; |
| | | | balance fan and motor |
| | | Red (Danger) | Stop cooling motor. |
| | | | Repair, replace, and/or |
| | | | rebalance fan |
| Hot Zone | Resistance to ground | Green (Satisfactory) | No action |
| | | Yellow (Caution) | Run a burnout cycle |
| | | | and recheck resistance |
| | | | to ground. If business |
| | | | rule persists, change |
| | | | ceramic at the heating |
| | | | element at the next |
| | | | maintenance interval |
| | | Red (Danger) | Alert to danger of |
| | | | arcing; change ceramic |
| | | | at the heating element |
| | | | before the next |
| | | | treatment cycle |
| | Arc detection sensor | Green (Satisfactory) | No action |
| | | Red (Danger) | Alert to danger of |
| | | | arcing; change |
| | | | ceramics at the heating |
| | | | element before the next |
| | | | treatment cycle; stop |
| | | | cycle immediately to |
| | | | cool furnace and check |
| | | | heating elements for |
| | | | arcing and repair as |
| | | | needed |
| | Open circuit sensor | Green (Satisfactory) | No action |
| | | Red (Danger) | Alert to open circuit; |
| | | | stop treatment cycle, |
| | | | open furnace and |
| | | | inspect heating |
| | | | elements to repair open |
| | | | circuit |
| | Power feed through | Green (Satisfactory) | No action |
| | water temperature | | |
| | sensor | | |
| | | Yellow (Caution) | Alert to rising |
| | | | temperature and check |
| | | | water flow |
| | | Red (Danger) | Alert to extreme |
| | | | temperature; stop |
| | | | treatment cycle; repair |
| | | | water flow to normal |
| | | | condition |
| Pumping System | Roughing pump - Oil | Green (Satisfactory) | No action |
| | temperature sensor | | |
| | | Yellow (Caution) | Check air filter, heat |
| | | | exchanger, and oil |
| | | | filter |
| | | Red (Danger) | Prevent roughing pump |
| | | | activation |
| | Roughing pump - | Green (Satisfactory) | No action |
| | Exhaust pressure | | |
| | sensor | | |
| | | Yellow (Caution) | Check exhaust filter |
| | | Red (Danger) | Replace exhaust filter |
| | Diffusion Pump - Oil | Green (Satisfactory) | No action |
| | Temperature sensor | | |
| | | Yellow (Caution) | Check air filter, heat |
| | | | exchanger, and oil |
| | | | filter |
| | | Red (Danger) | Prevent diffusion pump |
| | | | activation |
| | Diffusion Pump - | Green (Satisfactory) | No action |
| | Heating Power Usage | | |
| | sensor | | |
| | | Yellow (Caution) | Check incoming |
| | | | voltage, check heater |
| | | | resistance, and replace |
| | | | pump (display |
| | | | resistance value) |
| | | Red (Danger) | Check incoming |
| | | | voltage, check heater |
| | | | resistance, and replace |
| | | | pump (display |
| | | | resistance value); shut |
| | | | down diffusion pump |
| | | | to avoid back |
| | | | streaming of oil |
| | Holding Pump - Oil | Green (Satisfactory) | No action |
| | Temperature sensor | | |
| | | Yellow (Caution) | Check air filter, heat |
| | | | exchanger, and oil |
| | | | filter |
| | | Red (Danger) | Prevent holding pump |
| | | | activation |

In another embodiment of the invention, the method may include scanning the sensors 200 associated with one or more of furnace components selected from the group consisting of a hot zone system component, a vacuum integrity component, a pumping system component, and a cooling system component (Table 2). As set forth in Table 2, the specific method may include monitoring and measuring the representative data elements of certain components and, upon finding a present or future failure condition, providing an auto-diagnostic instruction. The auto-diagnostic instruction may be displayed to a user at the user interface 410 (e.g., real time dashboard) or, in alternative embodiments, provided to the furnace 100 automatically from a furnace controller 420.

TABLE 2
Exemplary Furnace Maintenance Process

| Furnace System | Measurement and Monitoring | Auto-Diagnostic Provided |
|---|---|---|
| Hot Zone System | Heating element | Replace heating element |
| | Resistance | |
| | Heat loss | |
| Vacuum Integrity System | Pumping down time | Run Burn-out cycle |
| | Leak up rate | |
| | Valve troubleshooting | |
| Pumping System | Pump amperage | Display indication that it is time |
| | Pump oil | for furnace maintenance |
| | Pump Vibration | |
| | Pump Temperature | |
| Cooling System | Blower amperage | Replace bearings |
| | Pressure drop heat | |
| | exchanger | |

The methods of the invention may be embodied, unless more specifically indicated, as a computer implemented process or processes and/or apparatus for performing such computer-implemented process or processes as described herein, and can also be embodied in the form of a tangible storage medium containing a computer program or other machine-readable instructions (i.e., “computer program”), wherein when the computer program is loaded into a computer or other processor and/or is executed by the computer, the computer becomes an apparatus for executing the process or processes. Storage media for containing such computer program include, for example, floppy disks and diskettes, compact disk (CD)-ROMs (whether or not writeable), DVD digital disks, RAM and ROM memories, computer hard drives and back-up drives, external hard drives, “thumb” drives, and any other storage medium readable by a computer. The process or processes can also be embodied in the form of a computer program, for example, whether stored in a storage medium or transmitted over a transmission medium such as electrical conductors, fiber optics or other light conductors, or by electromagnetic radiation, wherein when the computer program is loaded into a computer and/or is executed by the computer, the computer becomes an apparatus for practicing the process or processes. The process or processes may be implemented on a general purpose microprocessor or on a digital processor specifically configured to practice the process or processes. When a general-purpose microprocessor is employed, the computer program code configures the circuitry of the microprocessor to create specific logic circuit arrangements. Storage medium readable by a computer includes a medium that is readable by a computer per se or by another machine that reads the computer instructions for providing those instructions to a computer for controlling its operation. Such machines may include, for example, a punched card reader, a magnetic tape reader, a magnetic card reader, a memory card reader, an optical scanner, as well as machines for reading the storage media mentioned above.

A number of patent and non-patent publications may be cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

Moreover, as used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Furthermore, the transitional terms “comprising”, “consisting essentially of” and “consisting of” when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All devices, systems, and methods described herein that embody the present invention can, in alternate embodiments, be more specifically defined by any of the transitional terms “comprising,” “consisting essentially of” and “consisting of.”

What is claimed is:

1. A system for facilitating the maintenance of an industrial heat treating furnace, the system comprising:
a. a plurality of sensors connected to a corresponding plurality of furnace components in an industrial heat treating furnace, each of the sensors being configured to sense a parameter associated with operation of one of the furnace components and to generate a signal that is representative of the sensed parameter; and
b. a computing system connected to receive the signals from the plurality of sensors, the computing system being programmed to:
(i) convert the signals from the sensors into a plurality of data elements;
(ii) select representative data elements from each of the plurality of data elements, the representative data elements being indicative of the parameter sensed by one of the sensors;
(iii) analyze the representative data elements using at least one of a trend process, a rate of change process, and a predetermined value comparison process, to determine whether one or more of the furnace components requires maintenance or will require maintenance; and then
(iv) display information indicative of a status of one or more of the furnace components based on the analysis of the representative data elements;
wherein the trend process comprises comparing the representative data elements over a period of time and determining whether the representative data elements define a trend that indicates a failure condition associated with one or more of the furnace components as compared to a reference trend;
wherein the rate of change process comprises comparing the representative data elements over a period of time and determining whether a rate at which the representative data elements change in value indicates a failure condition associated with one or more of the furnace components as compared to a reference rate of change; and
wherein the predetermined value comparison process comprises comparing the representative data elements to one or more predetermined values indicative of a failure condition and determining whether the representative value indicates a failure condition associated with one or more of the furnace components as compared to the one or more predetermined values.

2. The system of claim 1, wherein the plurality of sensors comprises a pump sensor, a hot zone sensor, a control system sensor, a vacuum sensor, a cooling system sensor, a transport system sensor, and an atmosphere sensor.

3. The system of claim 2, wherein the pump sensor is selected from the group consisting of a roughing pump sensor, booster pump sensor, diffusion pump sensor, holding pump sensor, and a combination thereof.

4. The system of claim 2, wherein the pump sensor comprises an oil temperature sensor, a power sensor, a pressure sensor, a water temperature sensor, or a combination thereof.

5. The system of claim 2, wherein the hot zone sensor is selected from the group consisting of an arc detection sensor, a heating element resistance sensor, a heating power current sensor, a heating power voltage sensor, a vessel water temperature sensor, a front head water temperature sensor, a furnace temperature sensor, a resistance to ground sensor, an open circuit sensor, and a combination thereof.

6. The system of claim 2, wherein the vacuum sensor is selected from the group consisting of a pressure sensor, a leak sensor, and a combination thereof.

7. The system of claim 2, wherein the cooling system sensor is a vibration sensor.

8. The system of claim 2, wherein the atmosphere sensor is selected from the group consisting of an ambient temperature sensor, an ambient pressure sensor, an ambient humidity sensor, and a combination thereof.

9. The system of claim 1, wherein the furnace is an atmosphere furnace or a vacuum furnace.

10. The system of claim 1, wherein the computer system is programmed to run an auto-diagnostic process that automatically processes the representative data elements using at least one of a trend process and a rate of change process to determine whether one or more of the furnace components requires maintenance or will require maintenance in the absence of a direct user command.

11. The system of claim 1, wherein the computing system comprises a local terminal, a remote server, or a combination thereof.

12. The system of claim 11, wherein the remote server comprises a physical server or a cloud-based computing system.

13. The system of claim 11 wherein the industrial heat treating furnace has a programmable logic controller and the local terminal is not connected to the programmable logic controller.

14. The system of claim 1, wherein the computing system comprises:
a. a local terminal configured to receive the signals from the plurality of sensors, monitor the signals from each sensor; convert the signals from each sensor into a plurality of data elements, and transmit the plurality of data elements; and
b. a remote server configured to receive the plurality of data elements transmitted from the local terminal, select representative data elements from the plurality of data elements, and analyze the representative data elements using at least one of the trend process and the rate of change process to determine whether one or more of the furnace components requires or will require maintenance.

15. The system of claim 14, wherein the computing system comprises a sensor data receiver connected to the local terminal and configured to receive the signals from the plurality of sensors and transmit the signals to the local terminal.

16. The system of claim 15, wherein the local terminal comprises a transceiver that is responsive to a failure event-driven request to transmit the plurality of date elements to the remote server.

17. The system of claim 14, wherein the remote server comprises a cloud-based computing system.

18. The system of claim 1, wherein the computing system is programmed to perform a predictive maintenance routine.

19. The system of claim 1, wherein the computing system is configured to report to a user whether one or more of the components of the furnace requires maintenance or will require maintenance.

20. The system of claim 1, wherein the computing system comprises a non-transitory data storage device configured to store at least one of the plurality of data elements and the representative data elements.

21. A method for automatically determining whether a component of a furnace requires maintenance because of a present failure condition and for automatically determining whether a component of the furnace will require maintenance because of an expected failure condition, the method comprising the steps of:
a. sensing parameters associated with operation of furnace components with a plurality of sensors connected to a corresponding plurality of furnace components;
b. generating signals that are representative of the sensed parameters with the plurality of sensors;
c. receiving the signals from each sensor at a computer system, and performing the following steps with the computer system:
i. converting the signals from each sensor into a plurality of data elements;
ii. selecting representative data elements from each of the plurality of data elements, the representative data elements being indicative of a parameter associated with operation of one or more of the furnace components;
iii. analyzing the representative data elements by using at least one of a trend process, a rate of change process, and a predetermined value comparison process to determine whether one or more of the furnace components requires maintenance or will require maintenance; and then
d. displaying information indicative of a status of one or more of the furnace components based on the analysis of the representative data elements.

22. The method according to claim 21 wherein the step of analyzing the representative data elements using the trend process comprises the steps of:
(1) comparing the representative data elements over a period of time; and
(2) determining whether the representative data elements define a trend that indicates a failure condition of one or more of the furnace components as compared to a reference trend.

23. The method according to claim 21 wherein the step of analyzing the representative data elements using the rate of change process comprises the steps of:
(1) comparing the representative data elements over a period of time; and
(2) determining whether a rate at which the representative data elements change in value indicates a failure condition of one or more of the furnace components as compared to a reference rate of change.

24. The method according to claim 21 wherein the step of analyzing the representative data elements using the predetermined value comparison process comprises the steps of:
(1) comparing the representative data elements to a predetermined value indicative of a failure condition; and
(2) determining whether the representative data elements indicate a failure condition of one or more of the furnace components as compared to the predetermined value.

25. The method according to claim 21 wherein the sensed parameters are selected from the group consisting of a hot-zone furnace parameter, a vacuum-integrity parameter, a pumping system parameter, a cooling system parameter, a transport system parameter, an atmosphere parameter, and a combination thereof.

26. The method according to claim 21 wherein the step of displaying information indicative of a status of one or more of the corresponding components of the furnace comprises transmitting information indicative of a status of one or more of the furnace components to a real time dashboard.

27. The method according to claim 21 further comprising the step of transmitting at least one of the plurality of data elements and the representative data elements to a remote server.

28. The method according to claim 21 further comprising the step of storing at least one of the plurality of data elements and the representative data elements on a data storage device.

29. The method of claim 22 comprising the step of receiving the reference trend from a remote server.

30. The method of claim 23 comprising the step of receiving the reference rate of change from a remote server.

31. The method of claim 24 comprising the step of receiving the predetermined value from a remote server.

32. The method of claim 31, comprising the step of providing instructions to the furnace based on the analysis of the representative data elements to backfill the furnace to atmospheric pressure and to perform a heating cycle.

33. The method of claim 31, comprising the step of providing instructions to the furnace based on the analysis of the representative data elements to perform a burnout cycle.

34. The method of claim 31, comprising the step of providing instructions to the furnace based on the analysis of the representative data elements to terminate a heating cycle.

35. The method of claim 31, comprising the step of providing instructions to the furnace based on the analysis of the representative data elements to perform a cooling cycle.

36. The method of claim 31, comprising the step of providing instructions to the furnace based on the analysis of the representative data elements to power down.

37. The method according to claim 21 wherein the displaying step comprises providing instructions to a user based on the analysis of the representative data elements to check one or more sensors of the plurality of sensors.

38. The method according to claim 21 wherein the displaying step comprises providing instructions to a user based on the analysis of the representative data elements to check one or more of the furnace components.
